(19) United States
(12) Patent Application Publication
(10) Pub. No.: US 2021/0150457 A1
(43) Pub. Date: May 20, 2021

(54) SYSTEMS AND METHODS FOR ITEM REDELIVERY USING COMPUTER READABLE CODES

(71) Applicant: United States Postal Service, Washington, DC (US)

(72) Inventors: Karen F. Key, Haymarket, VA (US); Tiffany S. Jesse, Washington, DC (US); Iwon S. Kaiyuan, Fairfax, VA (US)

(21) Appl. No.: 17/097,887

(22) Filed: Nov. 13, 2020

Related U.S. Application Data
(60) Provisional application No. 62/935,485, filed on Nov. 14, 2019.

(51) Int. Cl. G06Q 10/08; G06K 7/14

(52) U.S. Cl. CPC G06Q 10/083; G06F 3/0482; G06K 7/1417

(57) ABSTRACT

Systems and methods for analyzing and improving delivery resource operation and efficiency. A delivery resource carries a mobile computing device which transmits delivery information to a server. The server combines the delivery information with stored route information for the route the delivery resource traverses to identify anomalies, to change routing, to dispatch additional resources, provide delivery predictions, and to improve overall performance.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57. This application claims the benefit of priority to U.S. provisional patent application No. 62/935,485 filed Nov. 14, 2019, the entire contents of which are hereby incorporated by reference.

### BACKGROUND

This disclosure relates to methods and systems for delivery, re-delivery, and/or pick-up of items.

### BRIEF DESCRIPTION OF THE DRAWINGS

FIG. 1 is a block diagram of a system for delivery of items.

FIG. 2A depicts an exemplary re-delivery form having a computer readable code thereon.

FIG. 2B depicts an exemplary re-delivery interface.

FIG. 3 depicts an exemplary process for re-delivery notices.

FIG. 4A depicts a front side of an exemplary item label.

FIG. 4B depicts a reverse side of the exemplary item label.

FIG. 4C depicts an exemplary process for initiating shipment of an item.

FIG. 5 depicts an exemplary code on packaging supplies.

FIG. 6A depicts an exemplary embodiment of a return label.

FIG. 6B depicts an exemplary embodiment of a return label.

FIG. 7A depicts an exemplary collection box.

FIG. 7B depicts an exemplary label on the collection box of FIG. 7A

### SUMMARY

Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and made part of this disclosure.

In one aspect described herein, a method of item delivery comprises receiving, in a processor, from a mobile delivery device, a first computer readable code from a scan of the first computer readable code located on a first physical distribution item; receiving, by a processor, from the mobile delivery device, a second computer readable code from a scan of the second computer readable code located on the re-delivery notice form; querying, by a processor, a memory, for item information corresponding to the first physical distribution item based on the received first computer readable code, the item information comprising re-delivery information; associating, by a processor, the item information with the second readable code; storing, by a processor, in the memory, the association between the item information and the second readable code; receiving, from a computing device of an intended recipient of the first physical distribution item, via a user interface, the second computer readable code from the scan of the second computer readable code on the re-delivery notice form by the intended recipient's computing device; providing, in the user interface, the re-delivery information, the redelivery information including a delivery point; receiving, in the user interface, a re-delivery time; and providing, via a processor, the re-delivery time to item processing equipment.

In some embodiments, the item information is encoded in the second readable code.

In some embodiments, providing the re-delivery information comprises populating fields of the user interface with the item information encoded in the second readable code.

In some embodiments, the method further comprises receiving, in a processor, from the mobile delivery device, a third computer readable code from a scan of the third computer readable code located on a second physical distribution item; querying, by a processor, a memory, for item information corresponding to the second physical distribution item based on the received third computer readable code, the item information comprising re-delivery information; and associating, by a processor, the item information for the second physical distribution item with the second readable code.

In some embodiments, the method further comprises receiving, from the computing device of the intended recipient, recipient information.

In some embodiments, the method further comprises comparing the received recipient information with the stored item information.

In some embodiments, the method further comprises determining whether the recipient information and the item information correspond to each other; and when the processor determines that the recipient information and the item information correspond, providing the re-delivery information via the user interface.

In some embodiments, the recipient information comprises the name and address of the intended recipient.

In some embodiments, the recipient information comprises a geographic location of the computing device of the user at the time of the scan of the second computer readable code by the intended recipient's computing device.

In some embodiments, determining whether the geographic location of the computing device at the time of the scan of the second readable code corresponds to the item information comprises: identifying a geographic location of delivery point from the item information; and determining whether the geographic location of the computing device is within a threshold distance of the geographic location of the delivery point.

In another aspect described herein, a system of item delivery comprises: a processor configured to: receive, from a mobile delivery device, a first computer readable code from a scan of the first computer readable code located on a first physical distribution item; receive, from the mobile delivery device, a second computer readable code from a scan of the second computer readable code located on the re-delivery notice form; query, a memory, for item information corresponding to the first physical distribution item based on the received first computer readable code, the item information comprising re-delivery information; associate the item information with the second readable code; store in the memory, the association between the item information and the second readable code; receive, from a computing device of an intended recipient of the first physical distribution item, via a user interface, the second computer readable code from the scan of the second computer readable code on the re-delivery notice form by the intended recipient's computing device; a user interface configured to: receive, from the processor, the re-delivery information, the redelivery information including a delivery point; receive, from the intended recipient, a re-delivery time; and item processing equipment configured to receive the re-delivery time from the user interface.

In some embodiments, the item information is encoded in the second readable code.

In some embodiments, the user interface is further configured to populate fields of the user interface with the item information encoded in the second readable code.

In some embodiments, the processor is further configured to receive from the mobile delivery device, a third computer readable code from a scan of the third computer readable code located on a second physical distribution item; query a memory for item information corresponding to the second physical distribution item based on the received third computer readable code, the item information comprising re-delivery information; and associate the item information for the second physical distribution item with the second readable code.

In some embodiments, the processor is further configured to receive, from the computing device of the intended recipient, recipient information.

In some embodiments, the processor is further configured to compare the received recipient information with the stored item information.

In some embodiments, the processor is further configured to determine whether the recipient information and the item information correspond to each other; and when the processor determines that the recipient information and the item information correspond, provide the re-delivery information via the user interface.

In some embodiments, the recipient information comprises the name and address of the intended recipient.

In some embodiments, the recipient information comprises a geographic location of the computing device of the user at the time of the scan of the second computer readable code by the intended recipient's computing device.

In some embodiments, the processor is further configured to identify a geographic location of delivery point from the item information; and determine whether the geographic location of the computing device is within a threshold distance of the geographic location of the delivery point.

### DETAILED DESCRIPTION

In the following detailed description, reference is made to the accompanying drawings, which form a part hereof. In the drawings, similar symbols typically identify similar components, unless context dictates otherwise. Thus, in some embodiments, part numbers may be used for similar components in multiple figures, or part numbers may vary depending from figure to figure. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and made part of this disclosure.

Reference in the specification to “one embodiment,” “an embodiment,” or “in some embodiments” means that a particular feature, structure, or characteristic described in connection with the embodiment is included in at least one embodiment of the invention. Moreover, the appearance of these or similar phrases throughout the specification do not necessarily all refer to the same embodiment, nor are separate or alternative embodiments necessarily mutually exclusive. Various features are described herein which may be exhibited by some embodiments and not by others. Similarly, various requirements are described which may be requirements for some embodiments but may not be requirements for other embodiments.

As used herein, the term “item” may refer to discrete articles in the distribution network, such as mail pieces, letters, flats, magazines, periodicals, packages, parcels, goods handled by a warehouse distribution system, baggage in a terminal, such as an airport, etc., and the like. The term item can also refer to trays, containers, conveyances, crates, boxes, bags, and the like. As used herein, the term delivery resource may refer to a carrier, who can be an individual assigned to a route who delivers the items to each destination. The term may also refer to vehicles or equipment, such as trucks, trains, planes, automated handling and/or delivery systems, processing equipment, and other components of the distribution network.

As described herein, a distribution network may comprise processing facilities such as regional distribution facilities, hubs, and delivery unit facilities, and other desired levels. For example, a nationwide distribution network may comprise one or more regional distribution facilities having a defined coverage area (such as a geographic area), designated to receive items from intake facilities within the defined coverage area, or from other regional distribution facilities. The regional distribution facility can sort items for delivery to another regional distribution facility, or to a hub level facility within the regional distributional facility's coverage area. A regional distribution facility can have one or more hub level facilities within its defined coverage area. A hub level facility can be affiliated with a few or with many delivery unit facilities, and can sort and deliver items to the delivery unit facilities with which it is associated. In the case of the United States Postal Service (USPS), the delivery unit facility may be associated with one or more ZIP codes. The delivery unit facility receives items from local senders, and from hub level facilities or regional distribution facilities. The delivery unit facility also sorts and stages the items intended for delivery to destinations within the delivery unit facility's coverage area. The delivery unit facility may be associated with one or more delivery routes.

The distribution network can deliver items to a plurality of delivery points. The delivery points can be associated with recipients or customers, such as by knowing names, identities, or other information about individuals or businesses that reside, are located at, or are otherwise associated with the delivery point. For example, a postal customer may register with the USPS and identify his or her name, a phone number, or other information and associate that information with the delivery point, or address. The distribution network can store these associations for use.

A customer or recipient may order an item to be delivered to his or her delivery point. In some embodiments, the item must be delivered to a person, may require a signature, requires a secure box in which to deliver the item, etc., as would be the case with a valuable item, high dollar item, controlled substance (such as pharmaceuticals), and the like. When no one is available to receive the item, the item cannot be delivered. A delivery resource, such as a carrier, can leave a notice regarding the delivery. The notice can be a missed delivery notice, a re-delivery notice, and/or the like. The notice can be a physical form, an image, a file, an electronic document, etc., sent to the intended recipient where the intended recipient has registered with the distribution network and provided an electronic communication address.

The re-delivery form can comprise one or more computer readable codes. The delivery resource can scan a first code on the notice, and can scan a code on the item. This can associate the item with the notice. A second code on the notice can be associated with the first code, and can be readable or scanned by the intended recipient using a mobile computing device, such as, for example, a smart phone or a tablet computer. The second code can schedule a redelivery, can identify an electronic parcel locker into which the item has been placed or into which it should be placed, can be used for in-person pick-up, and for other uses.

Implementing a re-delivery form having computer readable codes can improve distribution network efficiency, reduce the need for customers to call a customer service center, and minimize delay for item delivery. As a customer is able to use a mobile application to request and schedule re-delivery, the number of calls to a call center can be reduced significantly.

In some embodiments, an item label, such as a priority mail label or a standard size box may include a computer readable code, such as a 2-dimensional QR code. The computer readable code can be scanned by a user to provide access to a distribution network ecosystem, suite of applications or options, and the like, such as scheduling pickup, customer service, directing customers on scheduling, and other options for receipt and/or delivery of the item.

In some embodiments, an item label can be scanned by an item recipient to obtain information about the item, including origin, delivery, and the like. The item label can be scanned by the recipient to initiate a returns process via an application, being redirected to a website, such as the distribution network website or the website of the item sender, and the like. Scanning the computer readable code can also display locations of nearby distribution facilities for deposit of the item for returns. In some embodiments the computer readable code can be included by the item sender and include return information. In some embodiments, the computer readable code can be provided by the distribution network and can be accessed by an item sender, or can be associated with information provided by an item sender.

A computer readable code can be located on distribution equipment, such as collection facilities, collection boxes, deposit locations, and the like. For example, a collection box for USPS can have a computer readable code thereon. A user can scan the computer readable code with a mobile computing device to obtain information about the collection box including pick up times, the location of the nearest post office, whether the pick-up has occurred for the day, and the like.

In some embodiments, a customer can scan provide information and authorizations to the distribution network using computer readable codes. A customer can scan a computer readable code on a hold mail form in order to provide hold mail instructions to the USPS. The hold mail document can be obtained from USPS and can be scanned by a customer with a mobile computing device. The scanning of the computer readable code can re-direct the mobile computing device to a website, application, etc., where a customer can provide the hold mail authorization and information. The website, application, etc., can obtain information from the mobile computing device identifying the device user in order to confirm the identity of the customer requesting hold mail. In some embodiments, the customer can provide other authorizations to the distribution network by scanning the computer readable code on other various forms, and the distribution network can use identifying information associated with the mobile computing device and the requestor to confirm authorizations. For example, a customer can provide authorization to leave a package that requires signature authorization or other authorization at a door step or other location.

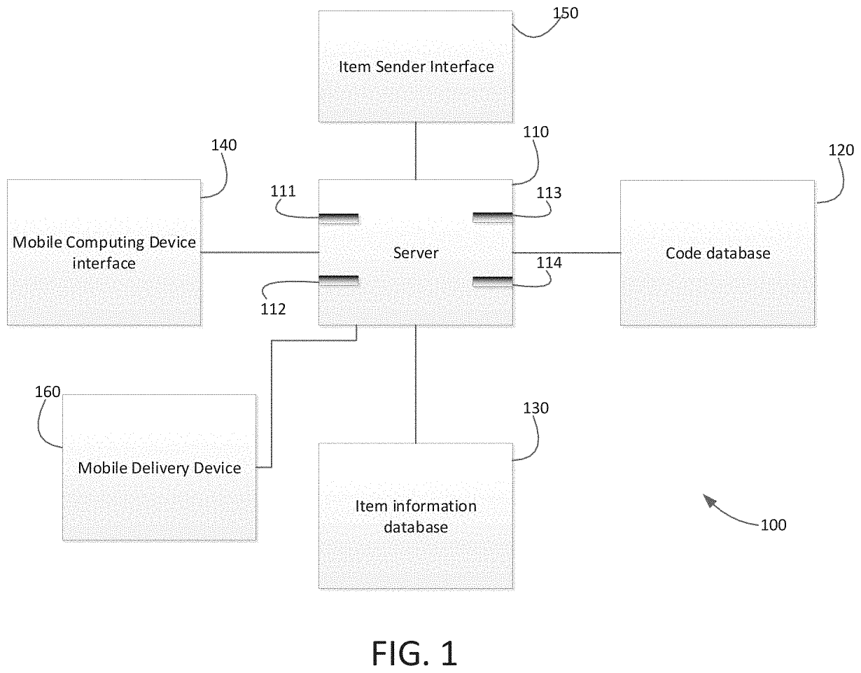

FIG. 1 is a block diagram of a distribution network computing system and interfaces with computer components. A system 100 includes a server 110, a code database 120, and item information database 130, a mobile computing device interface 140, an item sender interface 150, and a mobile delivery device 160.

The server 110 may comprise or be a component of a processing system implemented with one or more processors. The server 110 may be a network of interconnected processors housed on one or more terminals. The one or more processors may be implemented with any combination of general-purpose microprocessors, microcontrollers, digital signal processors (DSPs), field programmable gate arrays (FPGAs), programmable logic devices (PLDs), controllers, state machines, gated logic, discrete hardware components, dedicated hardware finite state machines, or any other suitable entities that may perform calculations or other manipulations of information. The server 110 may comprise a processor 111 such as, for example, a microprocessor, such as a Pentium® processor, a Pentium® Pro processor, a 8051 processor, a MIPS® processor, a Power PC® processor, an Alpha® processor, a microcontroller, an Intel CORE i7®, i5®, or i3® processor, an AMD Phenom®, A-series®, or FX® processor, or the like. The processor 111 typically has conventional address lines, conventional data lines, and one or more conventional control lines. The processor 111 may be in communication with a processor memory 112, which may include, for example, RAM memory, flash memory, ROM memory, EPROM memory, EEPROM memory, registers, hard disk, a removable disk, a CD-ROM, or any other form of storage medium known in the art. The processor memory 112 may include, for example, software, at least one software module, instructions, steps of an algorithm, or any other information. In some embodiments, the processor 111 performs processes in accordance with instructions stored in the processor memory 112. These processes may include, for example, controlling features and/or components of the expected delivery window generation system 100, and controlling access to and from, and transmitting information and data to and from the address analytical server system hub 110 and the constituent components of the expected delivery window generation system 100, as will be described herein.

The server 110 comprises a system memory 113, configured to store information such as operating instructions, APIs, interfaces and/or information for interacting with devices and system connecting to and communicating with the system 100. The system memory 113 may comprise a database, a comma delimited file, a text file, or the like. The server 110 is configured to coordinate and direct the activities of the components of the expected system 100, and to coordinate operations of the system 100 as described herein.

In some embodiments, the processor 111 is connected to a communication feature 114. The communication feature 114 is configured for wired and/or wireless communication. In some embodiments, the communication feature 114 communicates via telephone, cable, fiber-optic, or any other wired communication network. In some embodiments, the communication feature 114 communicates via cellular networks, WLAN networks, or any other wireless network. The communication feature 114 is configured to receive instructions and to transmit and receive information among components of the expected delivery window generation system 100, and in some embodiments, with other distribution network computers or computer systems (not shown) or other resource outside the depicted system 100, as desired.

The code database 120 can store information regarding computer readable codes, associations associated with the computer readable codes, information for reading computer readable codes, reading encrypted computer readable codes, and the like. When the server receives a computer readable code, or receives information indicative of a computer readable code from the mobile computing device interface 140, the server 110 can access, query, etc., the code database 120 to identify the type of computer readable code, to identify information associated with the received computer readable code, or any other information desired relating to the computer readable code. In some embodiments, the code database 120 stores an association between information stored in the computer readable code and a record locator or a pointer in the item information database 130 for a particular item, class of items, etc.

The code database 120 can identify whether the received code is for a re-delivery notice, for a hold mail authorization, a return service, a standard size package, express mail, and the like. The code database 120 communicates the code type to the server 110 and any instructions associated with the code type. The instructions can include APIs, information for redirecting a mobile computing device to an application or network location appropriate for the type of computer readable code being scanned.

In some embodiments, the code database 120 can generate computer readable codes in response to a request from the server 110, from an item sender interface 150, and/or from the mobile computing device interface 140. For example, a computer readable code can be requested by a sender or merchant for a return authorization, or a sender can request shipping materials with sender information encoded in the computer readable code or other instructions encoded within the computer readable code.

The item information database 130 can include a unique identifier for each item in the distribution network. The unique identifier for the item is used for tracking the item, routing the item, and for other processes within the distribution network. The item information database can store, in association with the item unique identifier, recipient identifiers, delivery point information, such as delivery addresses, as well as tracking and location information for the items to be delivered within the distribution network. The item information database 130 can also include associations with computer readable codes where applicable. In some embodiments, the item information database 130 can include other systems within a distribution network computing system.

The mobile computing device interface 140 can be a connection to a mobile computing device. The mobile computing devices can be smartphones, tablet computers, and the like. In some embodiments, although the words mobile computing devices are used, the mobile computing device interface can communicate with non-mobile computing devices, such as computer workstations, desktop computers, and the like. The mobile computing device interface 140 can be implemented in a mobile application, in a browser, via APIs, and the like.

The item sender interface 150 can be a connection to a computer network or computing device of a sender or merchant. For example, a merchant or sender may use the item sender interface 150 in order to send a computer readable code or a label having a computer readable code thereon to the distribution network for returns, tracking, or other purposes. The item sender interface can be implemented via APIs, via a web interface, and the like. A merchant can also provide returns rules, return payment, return instructions, such as delivery locations, and the like via the item sender interface 150.

The mobile delivery device 160 can be a mobile computing device carried by a distribution network resource as the resource delivers items to delivery points. The mobile delivery device 160 can be a smartphone, tablet computer, and the like, in communication with the server 110. The mobile delivery device 160 can have task specific menus, options, etc., on an interface thereof. In some embodiments, the mobile delivery device 160 can be similar to the MDD utilized by carriers in the USPS.

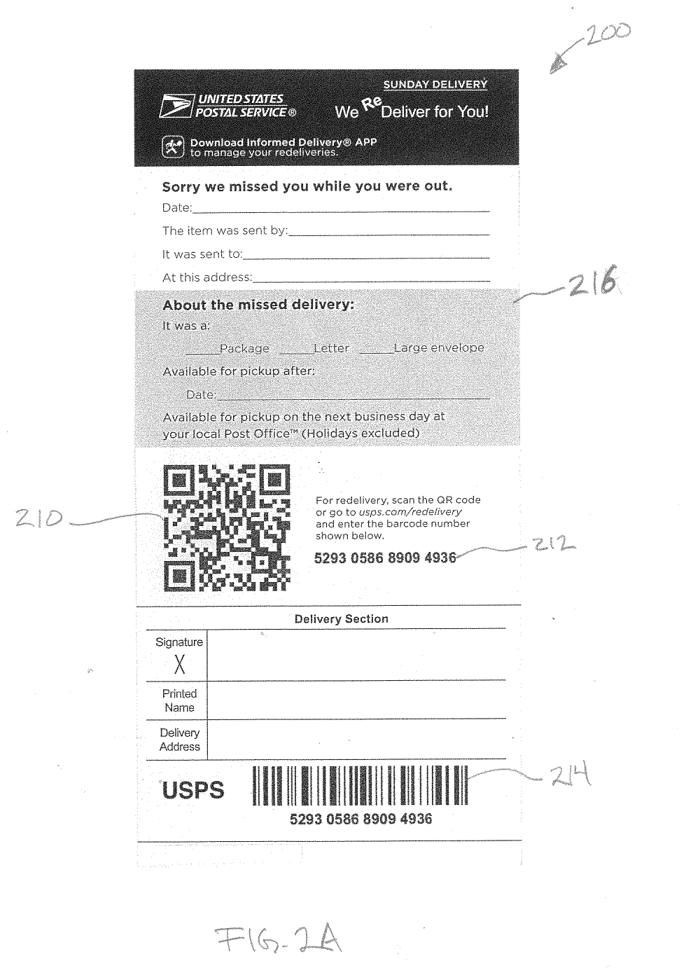

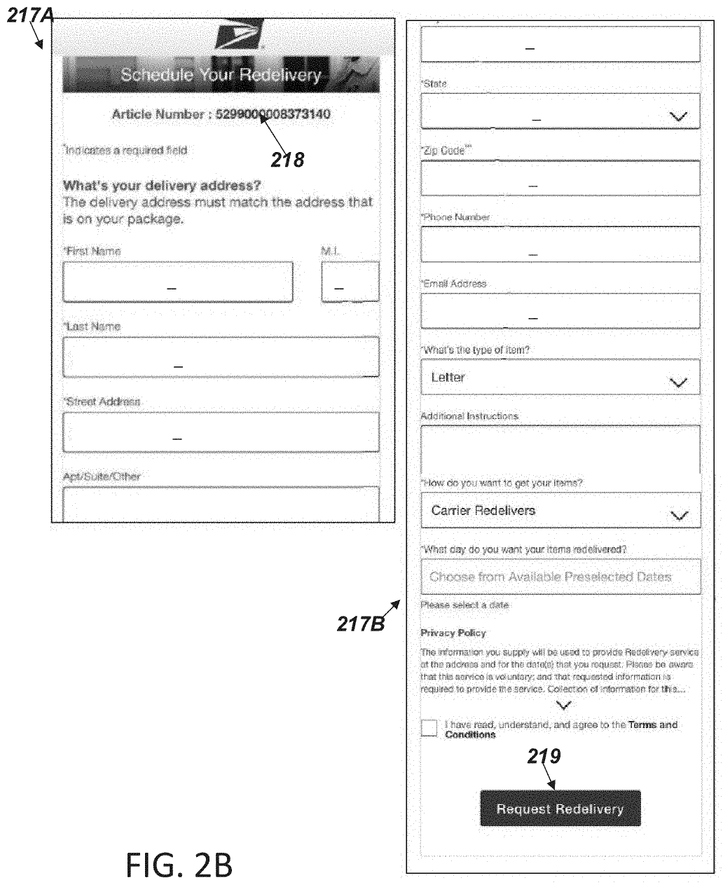

FIG. 2A depicts an exemplary re-delivery form having a computer readable code thereon. A form 200 can include a first computer readable code 210, a tracking number 212, a second computer readable code 214, and an information portion 216. The form 200 can be left on a door, mailbox, porch, or in another desired location by a delivery network resource. In the case of the USPS, the carrier can leave the form 200 on a door or doorstep after a delivery has been attempted, but no one was available to receive the item. The carrier can scan the first or second computer readable code 210, 214 using a mobile delivery device, in order to update the item information database 130 that an item was left, and to update the code database 120 that a form 200 was left at the intended delivery point for the item. In some embodiments, the carrier scans the item, and navigates to an option in the mobile delivery device for re-delivery. The carrier can then scan the first or second computer readable code 214 to associate the item code with the code or codes on the re-delivery form.

The first computer readable code 210 encodes item information, for example, item information that is specific to the item being delivered. The first computer readable code 210 can advantageously be a two dimensional barcode, such as a QR code. In some embodiments, the first computer readable code 210 is item agnostic. The first computer readable code 210 can encode a pointer to a network application or resource. For example, when a user scans the first computer readable code 210, the computer readable code contains information to route the computing device doing the scanning to a website, an application, and the like. In some embodiments, the user scans the first computer readable code 210 within an application provided by the distribution network, such as a USPS application. The mobile computing device interface 140 receives the scanned first computer readable code 210 and passes the information to the server 110. The server 110 queries the code database 120 to obtain information associated with the scanned first computer readable code 120. The server 110 the can display on the mobile computing device interface 140 instructions for the user, can reroute the user's mobile computing device to a website, can call up a specific portion of the mobile application, and the like. In some embodiments, the mobile computing device interface can provide access to a re-delivery scheduling program, utility, etc.

FIG. 2B depicts an exemplary interface for re-delivery. The re-delivery interface 217 includes portions 217A and 217B which can be a continuous scroll or a single interface which is depicted as portions 217A and 217B for convenience. The re-delivery interface 217 is generated or directed to by the scanning of the first computer readable code 210. The re-deliver interface is populated with the item number 218. The item number 218 can be the tracking number 212 from the form 200, or can be a tracking number associated with the item in item information database 130 that uniquely identifies the item in the distribution network. The re-delivery interface 217 can include a plurality of information fields for a user to fill in, including name, street address, state, ZIP code, phone number, and/or email address, for the user or recipient to identify him or herself In some embodiments, these fields can be automatically pre-populated based on login information for accessing the application through which the first computer readable code 210 was scanned. In some embodiments, the information in the plurality of fields can be provided based on information obtained from the item information database 130 related to the item to be delivered. In some embodiments, the information in the plurality of fields can be populated using information obtained from the mobile computing device and confirmed thorough a mobile service provider, for example. The server 110 can check that prepopulated information matches information for the intended recipient on the item to be delivered. If the prepopulated information does not match, the re-delivery cannot be rescheduled. If the prepopulated information matches the recipient information on the item to be delivered, then the re-delivery scheduling can proceed. In some embodiments, the name and address input into the plurality of fields must match that associated with the item and stored in the information database 130 in order to allow the user to schedule a re-delivery or to provide alternate delivery options. This can help improve the security of the redelivery process.

In some embodiments, for example, where the first computer readable code 210 is not scanned via an application, or where the first computer readable code 210 does not uniquely identify an item to be delivered, the interface 217 can prompt the user to input the tracking number 212, or another tracking number recognizable by the distribution network. This allows the distribution network to associate the re-delivery request with the item.

When the user has entered the information, the redelivery interface 217 can display the type of item to be delivered, e.g., letter, parcel, and the like. The re-delivery interface 217 can provide options for type of re-delivery, such as carrier re-delivers the item to the home of the recipient, to another address, to a parcel locker, or holding for pickup at a distribution network facility. The user selects a date for re-delivery, and presses a request re-delivery button 219. The server 110 receives the information and provides the redelivery information to the item information database 130 to route and schedule the item for re-delivery. In some embodiments, the item information database 130 or the server 110 can communicate the re-delivery request and information to any other system within the distribution network to cause the selected re-delivery to occur.

In addition to re-delivery services, in some embodiments, the computer readable code 210 can be used to access other distribution network services, such as change of address, hold mail, and other forms. The mobile computing interface 140 can identify the computer readable code 210, which can be specifically provided to accomplish a particular task, such as change of address or hold mail, or which can direct a user to an application or website where the user can select an option for a distribution network service, such as change of address or hold mail. By scanning the computer readable code 210 from an application, such as, for example, the Informed Delivery® application from USPS, where a user's information is stored in the application and/or on the mobile computing device, scanning the computer readable code 210 and transmitting the user information can provide authentication or login information acceptable to the server 210 to allow the transaction to be completed.

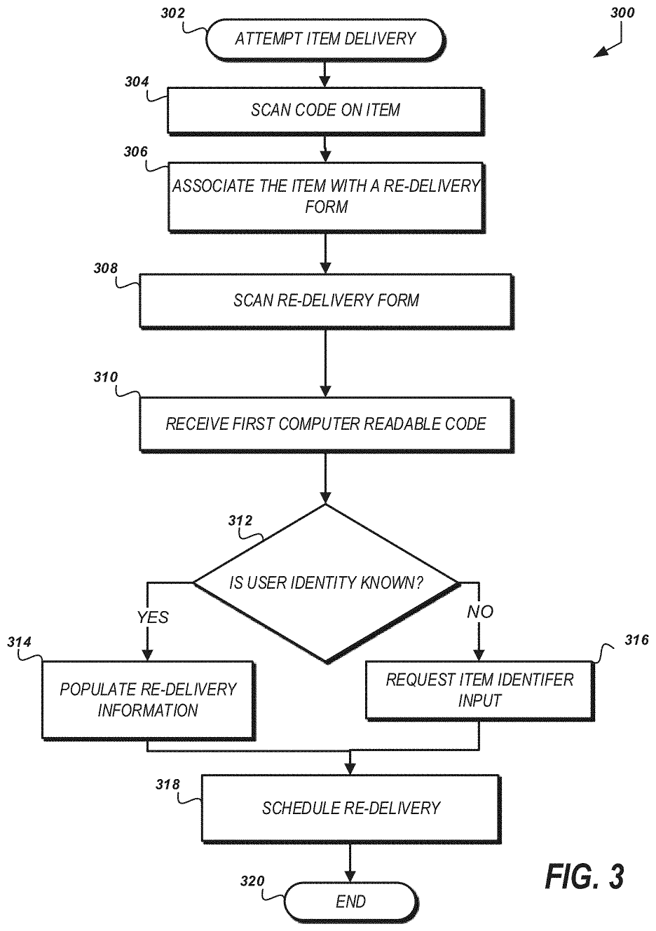

FIG. 3 depicts an exemplary process for re-delivery notices. A process 300 begins in block 302 wherein an item delivery is attempted. As described elsewhere herein, if the item delivery requires a person to receive the item, but no one is available to receive the item, then the delivery cannot be completed. There may be other reasons that a delivery cannot be completed, such as lack of access to a delivery location, like a porch, poor weather conditions, safety hazards at the delivery point, and the like.

In the event the item cannot be delivered, the process moves to 304, wherein the delivery resource scans a code on the item. This is done using the mobile delivery device 160. Scanning the code on the item accesses the item information from the item information database 130 including recipient, delivery point, unique item identifier, tracking information, and any other desired information. The mobile delivery device 160 provides options for a delivery resource to input the reason an item cannot be delivered, and other information.

The process 300 moves to block 306, wherein the item is associated with the re-delivery form 200. In one option, the delivery resource can associate the item with the re-delivery form by requesting via the mobile delivery device 160 to generate the re-delivery form 200. The delivery resource can select an option from the interface of the mobile delivery device 160 for redelivery of the item. On request, the mobile delivery device 160 or the server 110 can generate the form, and send the form to the mobile delivery device 160 or to an attached printer, to generate the form 200. The form 200 will have the unique identifier for the item encoded in the first computer readable code 210. The form 200 can include the unique identifier as the tracking number 212 and other item information. In some embodiments, the unique identifier can be encoded in the second computer readable code 214. The first computer readable code 210 can also encode other information, such as the reason the item could not be delivered. This information is stored in the item information database 130.

In some embodiments, the form 200 can be associated with more than one item, for example, if a recipient has more than one item for delivery that could not be delivered, a separate form 200 does not need to be used for each item. The first computer readable code 210 can encode the unique identifier for each of the items to be re-delivered.

In some embodiments, the carrier can indicate on the mobile delivery device 200 that a generic re-delivery form 200 will be used. The first computer readable code 210 of the generic form 200 does not encode a unique identifier for the item. A carrier may have a plurality of generic re-delivery forms 200, each of which include a unique tracking number. The generic form 200 is not associated with an item until the scan by the carrier occurs. For example, when a distribution network resource cannot deliver the item, the carrier obtains a generic form 200 from a stack of forms 200. Each form in the stack of forms 200 may have the same first computer readable code 210 thereon, or each can have a different first computer readable code 210. Each form in the stack of forms 200 has a different tracking number 212 thereon, and the first and/or second computer readable codes 210, 214 can encode the tracking number 212. To associate the generic form 200 with the item, the carrier scans either the first computer readable code 210 or the second computer readable code 214 on the form 200. Scanning the first or second readable code 210, 214 by the carrier generates and stores an association in the code database 120 and/or the item information database 130 between the unique identifier for the item and the first computer readable code 210, the tracking number 212, and/or the second computer readable code 214. In some embodiments, the mobile delivery device 160 instructs the delivery resource, when in a re-delivery mode, to scan the code on the item to be delivered, and then to scan the first or second computer readable code 210, 214 on the form 200, and the server 110 can establish the association between the item and the first and/or second readable codes 210, 214 on the form. In some embodiments, the mobile delivery device 160 instructs the delivery resource, when in a re-delivery mode, to scan the first or second computer readable code 210, 214 on the form 200, and then to scan the code on the item to be delivered, and the server 110 can establish the association between the item and the first and/or second readable codes 210, 214 on the form.

In some embodiments, the first computer readable code 210 can be associated with more than one item. If a carrier has more than one item to deliver to a delivery point, the process described above here can be repeated for each item, with the delivery resource scanning the first or second computer readable codes 210, 214 on the same generic form 200 as a previous item.

When the first or second computer readable code 210, 214 is scanned, the server 110 associates the unique identifier for the item with the first and/or second computer readable code 210, 214. If the first computer readable code 210 is not unique to each form 200, then the server 110 does not associate the unique identifier for the item with the first computer readable code 210, but associates the unique identifier with the second computer readable code 214. In some embodiments, the first computer readable code encodes the unique tracking number 212 from the form. In this case, the server 110 associates the unique identifier for the item with the first computer readable code 210. The scans and associations are stored in the item information database 130.

The process 300 moves to block 308, wherein the carrier scans the first and/or second computer readable codes 210, 214. In the case where the form 200 was generated for the item to be delivered, scanning the code can confirm that the form 200 has been correctly created, and or left for the intended recipient of the item.

In some embodiments, such as where a generic form 200 is used, the scan in block 308 can occur as part of the description above for block 306. In some embodiments, block 308 can be omitted.

The process 300 moves to block 310, wherein the mobile computing device interface 140 receives a scan of the first computer readable code 210. This could occur when an intended recipient scans the first computer readable code 210 on the form 200 which was left for the recipient by the delivery resource. The mobile computing device interface 140 passes the scan information to the server 110, which can query the code database 130 for instructions associated with the first computer readable code 210.

The process 300 moves to decision state wherein it is determined whether the user identity is known. The mobile computing device interface 140 can identify the access method, that is, whether the first computer readable code 210 was scanned via an application, a website, etc. In the case where the mobile computing device interface 140 is a mobile application the user has logged into, the mobile computing device interface 140 can determine that the user identity is known, based on the login information. The process 300 would then move to block 314. Additionally, in some embodiments, in the case where the first computer readable code 210 encodes the unique identifier and the recipient information, the process 300 moves to block 314.

In block 314, the server 110 instructs the mobile computing device interface 140 to populate re-delivery information into re-delivery application or program. The re-delivery information can include the address, recipient, item tracking number, unique identifier for the item, and/or any other desired information. In some embodiments, where there is more than one item for re-delivery to a given delivery point, the mobile computing interface 140 can provide a selection from known items that are to be delivered to the delivery point and provide a selection to the user. The user can select one, some, or all items to be re-delivered via a certain method on a certain day, or can choose different re-delivery types and times for different items.

The populated information can be changed or edited by a user, or can be fixed, and non-editable. This can increase security for items by not allowing a person to take a re-delivery form from a location, and attempting to schedule re-delivery to a different address. In order to change the address for re-delivery, a user may be required to login to an application, such as the USPS Informed Delivery® application.

In some embodiments, the user's mobile computing device has a location circuit, such as a GPS circuit. The re-delivery application can request and receive from the mobile computing device the geographic location of the mobile computing device when the mobile computing device scanned the first or second computer readable code 210, 214 on the re-delivery form 200 which was left at the delivery point. The server 110 can compare the GPS location of the mobile computing device with delivery point information for the intended delivery point for the item. For example, the server can determine if the GPS location of the user's mobile computing device corresponds to the address to which the item is to be delivered. If the GPS location matches the address, or is within a threshold distance of the GPS location, then the re-delivery process can proceed. If the GPS location does not match the address, then the re-delivery application may not allow scheduling re-delivery or providing different delivery instructions. In some embodiments, where the GPS location does not match, the re-delivery application may request additional information to confirm the identity of the entity requesting re-delivery.

In some embodiments, the mobile computing device interface 140 can obtain information from the mobile computing device scanning the form 200 to confirm identity. For example, the mobile computing device interface 140 may pass a telephone number, electronic serial number, or other information from the mobile computing device to the server 110, which can subsequently query an external system or computer to obtain identity information for the user of the device, such as name, mailing address, etc. If the server 110 receives information that does not match the name of the intended recipient of the item, or if the address does not match the address of the intended delivery point for the item as stored in the item information database 130, the server 110 can prevent scheduling of re-delivery, or can require a login or identity verification. The server 110 can also send an alert to the intended recipient via an email, text, or other method that scheduling re-delivery was attempted but was denied.

If the user identity is not known, the process 300 moves to block 316, wherein the mobile computing device interface 140 requests the item identifier is input. The item identifier can be the tracking number 212 from the form 200, or can be a tracking number given to the recipient at another stage, such as when the item was purchased, shipped, etc. In this case, the server 110 can perform identity verification steps as described above. In some embodiments, the user cannot edit the information in the mobile computing device. For example, when there is no login information available when the re-delivery application is accessed, the re-delivery application will not allow any delivery point information to be changed, or will not accept alternate delivery instructions. The delivery point associated with the scanned first or second code 210, 214 will be the delivery point to which the re-delivery will be attempted.

The process 300 moves to block 318, wherein the re-delivery is scheduled. The server 110 communicates the information to the item information database 130 and/or to any other connected system in order to affect re-delivery of the item.

The process 300 moves to block 320 and ends.

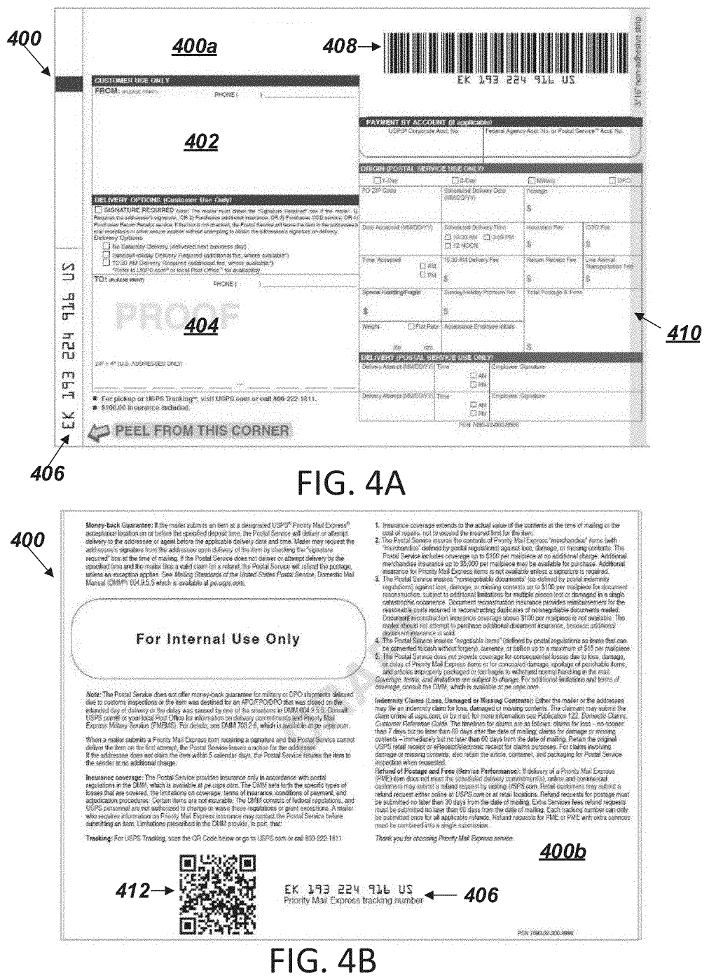

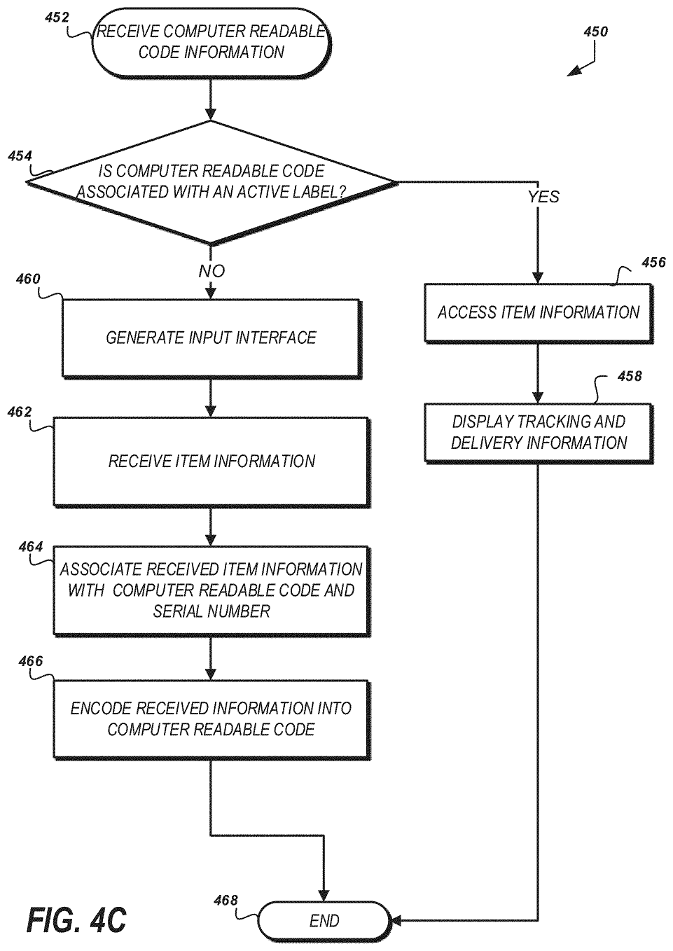

FIG. 4A depicts a front side of an exemplary label having a first computer readable code thereon. FIG. 4B depicts a reverse side of the exemplary label having a second computer readable code thereon. A label 400 can be used for certain classes of items in order to improve operational efficiency during induction, transportation, tracking, and delivery. The front side 400a of the label 400 includes an origin section 402, a delivery point section 404, a serial number 406, a first computer readable code 408, and an information section 410.

The origin section 402 can include sender information, such as, for example, a sender name, an origination point, a return address, and the like. The delivery point section 404 can include a recipient name, a delivery point, and the like. The serial number 406 can be a human readable alphanumeric string that is unique to the label 400. The serial number 406 for the label can be stored in the item information database 130, and before the label 400 is associated with an item, can include a blank record, or an indicator or flag that the label 400 is unused.

The first computer readable code 408 can be a barcode, a QR code, or any other desired computer readable code. The first computer readable code 408 is associated with the serial number 406. The first computer readable code 408 can be recognizable to item processing equipment, which will scan the first computer readable code 408 as the item on which the label 400 is placed moves through the distribution network. The serial number 406 and the first computer readable code 408 are associated and stored in the item information database 130. The first computer readable code 408 is also configured to be read and recognized by the mobile delivery device 160 when an item is being processed, for example, when the item is delivered to the delivery point shown in the delivery point section 404.

The information section 410 can include information for the distribution network and can include an induction point, such as the ZIP code of the induction facility, postage payments, insurance payments, delivery times, acceptance times, and any other desired information. This information can be added or input to the label when the item is inducted, when a label is generated, etc.

When a label is created, either at a distribution network facility, such as a post office, at a self-service kiosk, or via an application or website, the information in the origin section 402, the delivery point section 404, and the information section 404 can be added to the label 400 and stored in the item information database 130 along with an association with the serial number 406 and the first computer readable code.

The reverse side 400b of the label 400 includes the serial number 404 and a second computer readable code 412. In some embodiments, the second computer readable code 412 can be a computer readable code capable of storing more information than a standard 1-dimensional barcode, such as a QR code, an RFID tag, and the like. The second computer readable code 412 encodes the serial number 404 and other information, as desired. The second computer readable code 412 is associated with the first computer readable code 408 and the serial number 404 in the item information database 130. The second computer readable code 412 can be stored with an unused designation or flag prior to use of the label 400.

When a sender desires to send an item, the sender can obtain a physical version of the label 400. This can be done by the sender, or by a delivery resource at an induction facility, such as a clerk at a post office. The sender or the delivery resource can add the sender information, delivery point information, and other information to the physical label 400, and can also input the same information into the item information database 130. The sender or the delivery resource can scan the first computer readable code 408 and/or the second computer readable code 412 to create an active label, to change the state of flag of the first and second computer readable codes 408, 412 to active labels, and/or to associate the inputted information with the first and second computer readable codes 408, 412.

The front side 402a of the physical version of the label 400 is removed from a backing and is adhered to the item. As the item moves through the distribution network, item processing equipment can scan the first computer readable code 408 and create and store tracking information for the item in the item information database 130.

The reverse side 402b of the physical version of the label 400 is retained by the sender. The sender can access the mobile computing device interface 140 as described elsewhere herein. Using a mobile computing device, the sender can scan the second computer readable code 412. The server 110 can receive the second computer readable code 412 from the mobile computing device interface 140, and can access all the information associated with the second computer readable code 412, including tracking and delivery information. The serial number 404 can be encoded into the second computer readable code 412, along with a pointer to a tracking website, application, etc. Thus, a sender need only scan the second computer readable code 412, and the server 110 will direct the sender's computing device to the appropriate program, interface, website, etc., and will also perform the look-up using the serial number 406 with no additional input from the sender.

In some embodiments, the sender can request to create a label 400 via the mobile computing device interface 140 or via the item sender interface 150. A sender may have an item that the sender desires to send with a high class of service, such as Priority Mail®, or other similar class. The user may obtain a physical version of the label 400 or can initiate the process electronically.

The information and features described with regard to the first side 402a and the second side 402b are exemplary only, and can be moved, altered, switched, etc., without departing from the scope of the current disclosure. For example, the first side 402a need not contain all the information described, or can include additional information. The information described on the reverse side 402b need not be on the reverse side of the first side 402a, but could be on the first side 402a of the label 400, but is not part of the first side 402a that is removed and applied to the item.

FIG. 4C depicts an exemplary process for initiating shipment of an item having the label 400 thereon. A process 450 begins in block 452, wherein the server 110 receives a scan of a computer readable code. This can occur, for example, when a user scans, via a computing device, the second computer readable code 412 on the reverse side 402b of the label 400. The mobile computing device interface 140 and/or the item sender interface 150 can receive the scan of the second computer readable code 412, and send the scanned code to the server 110. The sender can scan the second computer readable code 412 in an application provided by the distribution network, such as the USPS's Informed Delivery® application. In some embodiments, the second computer readable code 412 can point to a website, internet address, application, etc., which can cause the computing device to be routed or pointed to a website or internet address, or can cause an application to be opened.

The process 450 moves to decision state 454, wherein the server 110 determines whether the received second computer readable code 412 is associated with an active label or active item. The server 110 queries the item information database using the information encoded in the second computer readable code 412 to determine whether the second computer readable code 412 or the serial number 406, has an active status or active flag, or an unused status or inactive flag in the item information database 130.

If the computer readable code 412 and/or the serial number 406 have an active status or flag, the process 450 moves to block 456, wherein the server 110 requests and receives item tracking information associated with the second computer readable code 412 and/or the serial number 406.

In some embodiments, the computer readable code 412 can be scanned from within an application. The user may be logged in to the application, and/or the user can be identified within the application. When the computer readable code 412 is scanned by a user via a mobile computing device interface 140 or an item sender interface 150 running the application, the computer readable code 412 is sent to the server 110. The server 110 accesses items and/or tracking information associated with the user identified by the application, and the server can provide to the mobile computing device interface 140, or to the item sender interface 150, a selectable list of items associated with the user, such as those sent by or being delivered to, the user. In some embodiments, the server 110 can send tracking information for one, several, or all items sent by or intended for delivery to the user. In this embodiment, the computer readable code 412 need not encode user specific information or be associated with any particular item, but provides instructions to the application.

The process 450 moves to block 458, wherein the server 110 sends the received tracking information to the computing device via the mobile computing device interface 140 and/or the item sender interface 150. The process moves to block 468 and ends.

If the second computer readable code 412 and/or the serial number 406 are not associated do not have an active status or active flag, the process 450 moves to block 460, wherein the server 110 generates an input interface. The sender can input information regarding the item into the input interface. For example, the sender can input sender information, delivery information including recipient name and address, postage payment information, item dimensions, a photograph or image of the item, and the like.

The process 450 moves to block 462, wherein the server 110 receives the inputted information and determines which information to use to populate the label. In some embodiments, in addition to generating the input interface, the server 110 can request that the sender take a photograph, using the mobile computing device, of the label on which the sender has written origination and recipient information. The server 110 can receive and character recognize the origination and recipient information written on the label 400. The server 110 can compare the inputted information with the recognized information from the photograph to confirm they are similar or the same. If there is a discrepancy, or dissimilarity, the server 110 can notify the sender of the same.

In some embodiments, block 460 need not be performed, and the server 110 can receive the origination and recipient information, including names and addresses, from a photograph of the label 400 where the sender as written in the appropriate information into the fields on the label 400.

The process 450 moves to block 464, wherein the server 110 associates the received information with the first and second computer readable codes 408, 412, and with the serial number 406. This association can be stored in the item information database 130. The server 110 can additionally record a creation event for the label 400 and store the same. The creation event can include updating an inactive or unused status or flag to an active status or flag.

The process 450 moves to block 466, wherein the received information can be encoded into the second computer readable code 412. For example, the second computer readable code 412 may encode characters or other data which is not initially associated with any information, but is a blank or placeholder in the second computer readable code 412. The server 110 can associate the blank or placeholder information with sender information, recipient information, or postage information, as desired. In some embodiments, block 466 can be omitted.

The user can then schedule a pick-up of the item, provide payment, and the like via the interface. The process 450 then ends in block 468.

In some embodiments, the process 450 can begin in step 460, where the server 110 generates an input interface. This can occur where a sender does not have a physical version of the label 400, but desires to generate a label having a tracking second computer readable code thereon. The sender can input all the relevant information into the input interface as requested by the server 110. The server can receive the item information, and can generate an electronic version of the label 400. The server 110 can generate the first and second computer readable codes 408, 412, and the serial number 406 that will be on the physical version of the label 400 when the physical label is generated. In block 466, the server 110 can encode the serial number, sender and recipient information, and any other desired information into the second computer readable code 412. Computing time can be reduced by encoding information directly into the second computer readable code 412, to avoid the need for the server to use the decoded information from the secondary computer readable code 412 to access the associated information in the item information database 130.

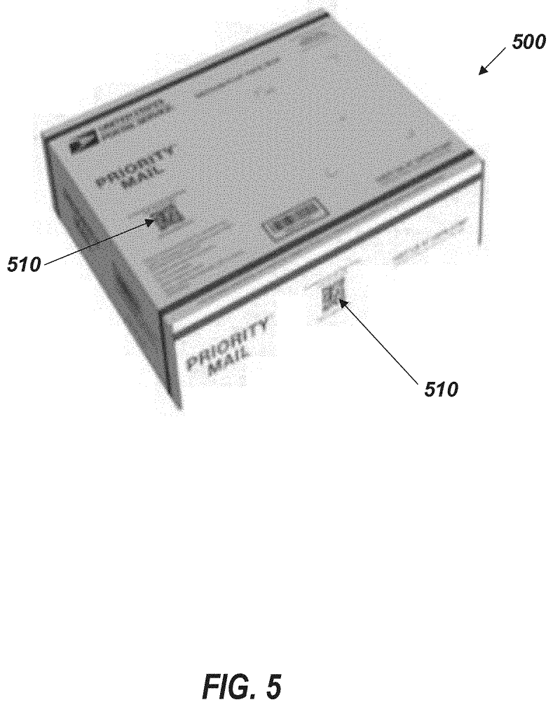

FIG. 5 depicts an exemplary code on packaging supplies. A package or box 500 can have a computer readable code 510 printed or affixed thereon. The computer readable code 510 can be unique to the box 500. In some embodiments, the computer readable code 510 can encode dimensions of the box 500, postage requirements, service class, and the like. The computer readable code 510 can be similar to those described elsewhere. For example, in some embodiments, the computer readable code 510 can direct a computing device scanning the computer readable code 510 to a specific or desired website, portal, application, etc. Steps of this process can be similar to those of process 450, for example, inputting information into the interface, accessing the interface, and the like. From the application, website, portal, etc., a user scanning the computer readable code 510 can schedule a pickup for the package or box 500. If the user is using an application to which the user has logged in, or which has stored user information, such as identity, address, etc., scanning the computer readable code 510 can transmit to the distribution network the address or location of the pickup point, the sender information, and the like.

In some embodiments, where the computer readable code 510 is scanned using a mobile computing device equipped with GPS or similar location detection feature, upon scanning the code, the application, program, website, can access the location of the mobile computing device, and can transmit to the server 110 the location of the mobile computing device. The transmitted location of the mobile computing device can be set as the pick-up point or location for the carrier to pick up the box 500. In some embodiments, the server 110 can compare the received coordinates of the mobile computing device, and can query a memory to determine an address associated with the location of the mobile computing device.

In some embodiments, scanning the computer readable code 510 with a mobile computing device causes the mobile computing device to display and/or access the mobile computing device interface 140, wherein the user can input information regarding the item and the box 500 containing the item to send. The information can include sender information, origination point information, intended delivery point, recipient, payment information, and the like.

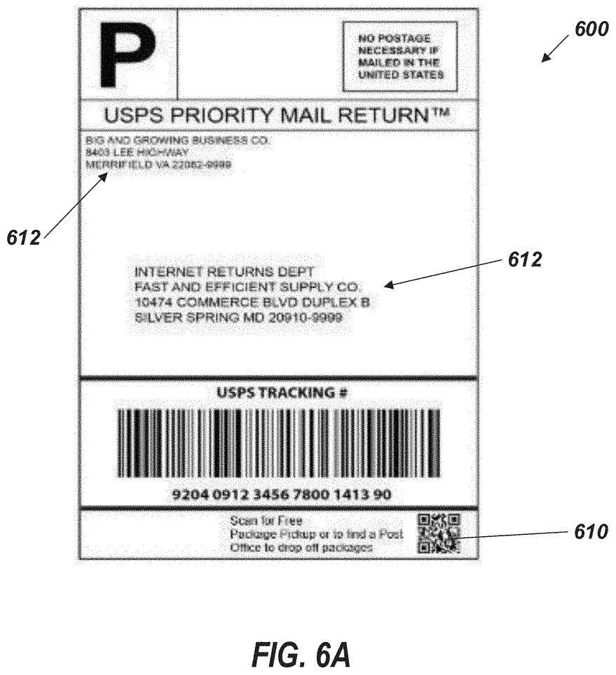

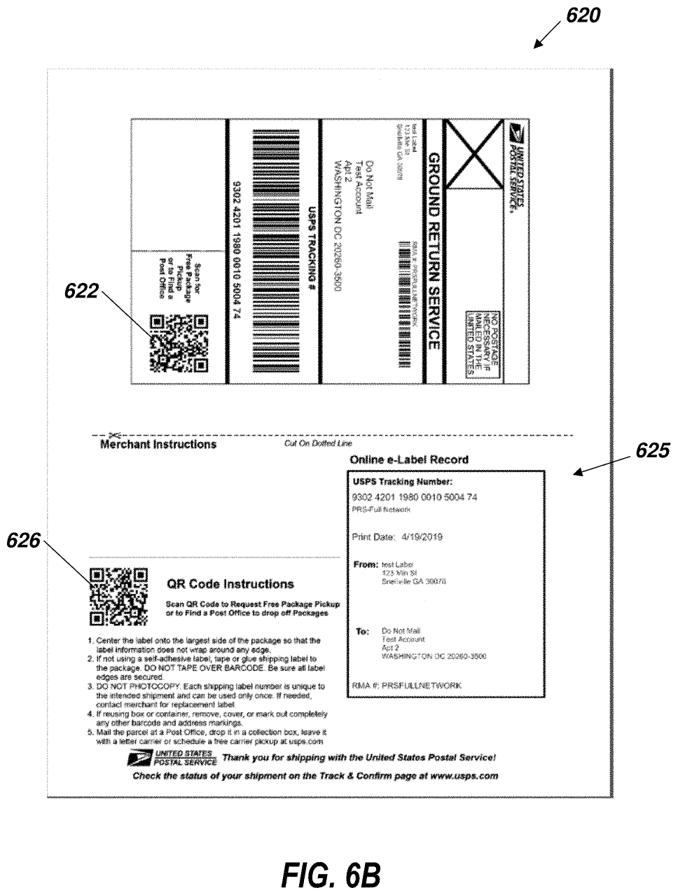

FIG. 6 depicts an exemplary shipment label for an item. A label 600 includes a computer readable code 610. The label 600 depicted is a USPS return label, but it will be understood that other labels can be used without departing from the scope of the current disclosure.

The computer readable code 610 can be similar to those described elsewhere herein. The computer readable code 610 can be included on a shipping label attached to the outside of a package, such as the original delivery shipping label. The original shipping label can have the origin address and the recipient address thereon, and can include the computer readable code 610. If the user wishes to return the item sent in the package, the user can scan the computer readable code 610 to initiate a returns transaction. The steps of scanning the code, accessing interfaces, and the like can be similar to those described herein with regard to FIGS. 4C and 5. In some embodiments, and as shown in FIG. 6, the computer readable code 610 can be on a return label 600 which is included with a shipment of a package. The label 600 can have the delivery address 612 thereon, and the merchant address 614 thereon. In some embodiments, the merchant address 614 can be the return address, or the address of the original recipient of the package.

A sender who desires to use a label 600 to provide return service to its customers can register with the distribution network, such as with the USPS, via the item sender interface 150. Via the item sender interface 150, the sender can receive from the server 110 computer readable codes 610 to print on their labels, or can provide to the server 110 computer readable codes 610 that will be on the labels. The sender can request that the server encode specific information into the computer readable codes 610, or can provide computer readable codes 610 that encode the specific information to the server 110. For example, a sender may encode into the label the address of a returns facility, and unique identifier to identify the particular item or sender, etc.

When a user receives a package and wishes to return the item, the user can, using a computing device, scan the computer readable code 610. As described elsewhere herein, the computer readable code 610 can include instructions and information to direct the computing device to an interface for scheduling pick-up, requesting return, initiating a return, etc. The user may scan the computer readable code 610 from within an application, for example, from within the Informed Delivery® application provided by USPS.

When the computer readable code 610 is scanned, the mobile computing device interface 140 is accessed. The mobile computing device interface 140 can decode the specific information encoded within the computer readable code 610 and can populate relevant fields or pass relevant information to the server 110. The mobile computing device interface 140 can display selectable options to schedule a pick-up or find the nearest distribution facility, such as a post office. The pickup can be scheduled as described elsewhere herein. If the mobile computing device interface 140 is running on a mobile computing device that has location capability, the location capability can be used to determine the nearest distribution facility.

In some embodiments, the mobile computing device interface 140 can receive the specific information regarding the returns facility to which the item will be shipped. The mobile computing device interface 140 can pass this information to the server 110, and postage can be calculated based on the location of the mobile computing device or the original delivery point, and based on the location of the returns facility. Postage can be requested from the user via the mobile computing device interface 140, or can be charged to the original item sender or to an account thereof.

In some embodiments, the mobile computing device interface 140 can provide additional returns instructions. The additional returns instructions can be encoded or stored within the computer readable code 610, or can be associated with the computer readable code 610, such as those that were provided by a sender via the item sender interface 150. The returns instructions can include the time frame for when the returns are authorized, can include instructions about how to package the item for return, such as requirements for items having batteries therein.

FIG. 6B depicts an exemplary embodiment of a return label. A return label 620 may have a computer readable code 622 thereon. The computer readable code 625 can be similar to computer readable codes described elsewhere herein. The return label 620 includes a detachable portion 625 which has a duplicate computer readable code 626 thereon. The user can, at a point after the package has been picked up, scan the duplicate computer readable code 626 and access tracking information for the returned item, similar to processes described elsewhere herein. The mobile computing device interface 140 can also access information regarding whether the merchant received the item, whether the merchant accepted the item, and whether a credit was issued for the return of the item. This information can be provided from the merchant via the item sender interface 150.

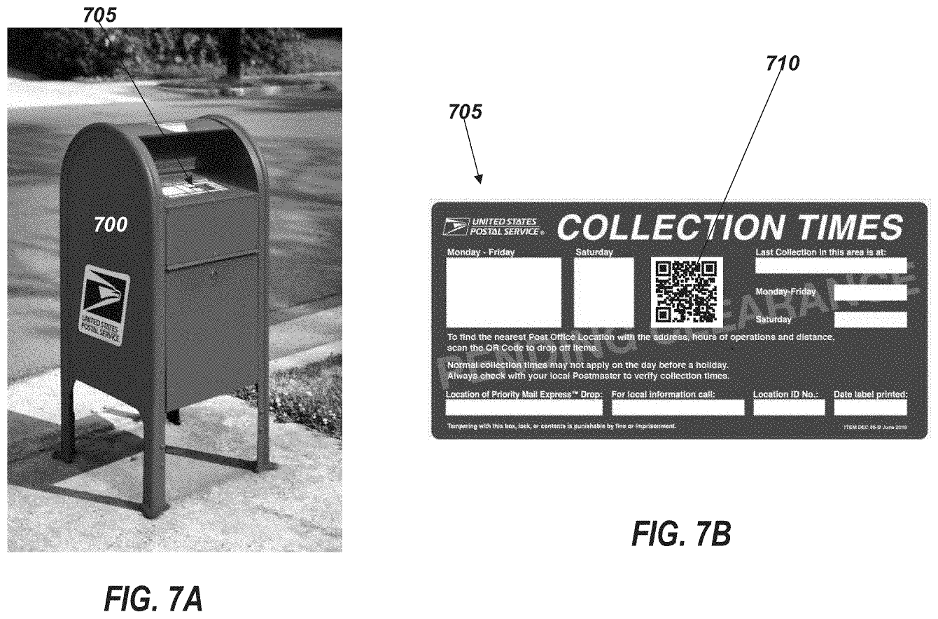

FIG. 7A depicts an exemplary collection box. FIG. 7B depicts an exemplary label on the collection box of FIG. 7A. A collection box 700 can be a receptacle designed to receive items which will be shipped via a distribution network. In some embodiments, the collection box can be a USPS collection box, such as that depicted in FIG. 7A. The collection box 700 is not limited to USPS collection boxes, however. The collection box can be any type of receptacle designed or configured to receive an item therein. The collection box 700 has a label 705 attached thereto.

The label 705 has a computer readable code 710 thereon. The computer readable code 710 can be similar to computer readable codes described elsewhere herein. The computer readable code 710 can encode location coordinates for the collection box 700 on which the label 705 is located, and can encode the pickup times and nearest distribution facilities. In some embodiments, the computer readable code 710 can include a unique identifier that is passed to the server 110, and the server can access information associated with the unique identifier, and thus with the collection box on which the label 705 is located.

The computer readable code 710 can direct a user's mobile computing device to the mobile computing device interface 140, where information regarding the collection box can be provided. The information can include pick up times, whether the last pick up for the day has occurred (based on the time of the scanning of the computer readable code 710), the location of the nearest distribution facility, such as a post office, and any other desired information. In some embodiments, the mobile computing device interface 140 can open a mapping application and can show all the distribution facilities with a set distance or radius from the collection box 700. In some embodiments, the server 110 can provide the locations of other collection boxes within a distance of the collection box 700 having the computer readable code 710 which was scanned. In some embodiments, the user scanning the computer readable code can request to be shown the locations of collection boxes for which the last pickup of the day has not yet occurred.

In some embodiments the computer readable code 710 can trigger an augmented reality display, with the mobile computing device interface 140 providing an augmented reality view of the pickup times, the location of the nearest post office as determined based on the geographic location of the user at the time of the scan, and/or any other information desired or described herein.

The various illustrative logical blocks, modules, routines, and algorithm steps described in connection with the embodiments disclosed herein can be implemented as electronic hardware, or as a combination of electronic hardware and executable software. To clearly illustrate this interchangeability, various illustrative components, blocks, modules, and steps have been described above generally in terms of their functionality. Whether such functionality is implemented as specialized hardware, or as specific software instructions executable by one or more hardware devices, depends upon the particular application and design constraints imposed on the overall system. The described functionality can be implemented in varying ways for each particular application, but such implementation decisions should not be interpreted as causing a departure from the scope of the disclosure.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each is present.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

As used herein, the terms “determine” or “determining” encompass a wide variety of actions. For example, “determining” may include calculating, computing, processing, deriving, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing, and the like.

As used herein, the term “selectively” or “selective” may encompass a wide variety of actions. For example, a “selective” process may include determining one option from multiple options. A “selective” process may include one or more of: dynamically determined inputs, preconfigured inputs, or user-initiated inputs for making the determination. In some implementations, an n-input switch may be included to provide selective functionality where n is the number of inputs used to make the selection.

As used herein, the terms “provide” or “providing” encompass a wide variety of actions. For example, “providing” may include storing a value in a location for subsequent retrieval, transmitting a value directly to the recipient, transmitting or storing a reference to a value, and the like. “Providing” may also include encoding, decoding, encrypting, decrypting, validating, verifying, and the like.

As used herein, the term “message” encompasses a wide variety of formats for communicating (e.g., transmitting or receiving) information. A message may include a machine readable aggregation of information such as an XML, document, fixed field message, comma separated message, or the like. A message may, in some implementations, include a signal utilized to transmit one or more representations of the information. While recited in the singular, it will be understood that a message may be composed, transmitted, stored, received, etc. in multiple parts.

All references cited herein are incorporated herein by reference in their entirety. To the extent publications and patents or patent applications incorporated by reference contradict the disclosure contained in the specification, the specification is intended to supersede and/or take precedence over any such contradictory material.

The term “comprising” as used herein is synonymous with “including,” “containing,” or “characterized by,” and is inclusive or open-ended and does not exclude additional, unrecited elements or method steps.

The above description discloses several methods and materials of the present invention. This invention is susceptible to modifications in the methods and materials, as well as alterations in the fabrication methods and equipment. Such modifications will become apparent to those skilled in the art from a consideration of this disclosure or practice of the invention disclosed herein. Consequently, it is not intended that this invention be limited to the specific embodiments disclosed herein, but that it cover all modifications and alternatives coming within the true scope and spirit of the invention as embodied in the attached claims.

What is claimed is:

1. A method of item delivery, the method comprising:
receiving, in a processor, from a mobile delivery device, a first computer readable code from a scan of the first computer readable code located on a first physical distribution item;
receiving, by a processor, from the mobile delivery device, a second computer readable code from a scan of the second computer readable code located on the re-delivery notice form;
querying, by a processor, a memory, for item information corresponding to the first physical distribution item based on the received first computer readable code, the item information comprising re-delivery information;
associating, by a processor, the item information with the second readable code;
storing, by a processor, in the memory, the association between the item information and the second readable code;
receiving, from a computing device of an intended recipient of the first physical distribution item, via a user interface, the second computer readable code from the scan of the second computer readable code on the re-delivery notice form by the intended recipient's computing device;
providing, in the user interface, the re-delivery information, the redelivery information including a delivery point;
receiving, in the user interface, a re-delivery time; and
providing, via a processor, the re-delivery time to item processing equipment.

2. The method of claim 1, wherein the item information is encoded in the second readable code.

3. The method of claim 2, wherein providing the re-delivery information comprises populating fields of the user interface with the item information encoded in the second readable code.

4. The method of claim 1, further comprising:
receiving, in a processor, from the mobile delivery device, a third computer readable code from a scan of the third computer readable code located on a second physical distribution item;
querying, by a processor, a memory, for item information corresponding to the second physical distribution item based on the received third computer readable code, the item information comprising re-delivery information; and
associating, by a processor, the item information for the second physical distribution item with the second readable code.

5. The method of claim 1 further comprising receiving, from the computing device of the intended recipient, recipient information.

6. The method of claim 5, further comprising, in a processor, comparing the received recipient information with the stored item information.

7. The method of claim 6, further comprising:
determining, in a processor, whether the recipient information and the item information correspond to each other; and
when the processor determines that the recipient information and the item information correspond, providing the re-delivery information via the user interface.

8. The method of claim 7, wherein the recipient information comprises the name and address of the intended recipient.

9. The method of claim 7, wherein the recipient information comprises a geographic location of the computing device of the user at the time of the scan of the second computer readable code by the intended recipient's computing device.

10. The method of claim 9, wherein determining whether the geographic location of the computing device at the time of the scan of the second readable code corresponds to the item information comprises:
identifying a geographic location of delivery point from the item information; and
determining whether the geographic location of the computing device is within a threshold distance of the geographic location of the delivery point.

11. A system of item delivery, the system comprising:
a processor configured to:
receive, from a mobile delivery device, a first computer readable code from a scan of the first computer readable code located on a first physical distribution item;
receive, from the mobile delivery device, a second computer readable code from a scan of the second computer readable code located on the re-delivery notice form;
query, a memory, for item information corresponding to the first physical distribution item based on the received first computer readable code, the item information comprising re-delivery information;
associate the item information with the second readable code;
store in the memory, the association between the item information and the second readable code;
receive, from a computing device of an intended recipient of the first physical distribution item, via a user interface, the second computer readable code from the scan of the second computer readable code on the re-delivery notice form by the intended recipient's computing device;
a user interface configured to:
receive, from the processor, the re-delivery information, the redelivery information including a delivery point;
receive, from the intended recipient, a re-delivery time; and
item processing equipment configured to receive the re-delivery time from the user interface.

12. The system of claim 11, wherein the item information is encoded in the second readable code.

13. The system of claim 12, wherein the user interface is further configured to populate fields of the user interface with the item information encoded in the second readable code.

14. The system of claim 11, wherein the processor is further configured to:
receive from the mobile delivery device, a third computer readable code from a scan of the third computer readable code located on a second physical distribution item;
query a memory for item information corresponding to the second physical distribution item based on the received third computer readable code, the item information comprising re-delivery information; and
associate the item information for the second physical distribution item with the second readable code.

15. The system of claim 11, wherein the processor is further configured to receive, from the computing device of the intended recipient, recipient information.

16. The system of claim 15, wherein the processor is further configured to compare the received recipient information with the stored item information.

17. The system of claim 16, wherein the processor is further configured to:
determine whether the recipient information and the item information correspond to each other; and
when the processor determines that the recipient information and the item information correspond, provide the re-delivery information via the user interface.

18. The system of claim 17, wherein the recipient information comprises the name and address of the intended recipient.

19. The system of claim 17, wherein the recipient information comprises a geographic location of the computing device of the user at the time of the scan of the second computer readable code by the intended recipient's computing device.

20. The system of claim 19, wherein the processor is further configured to:
identify a geographic location of delivery point from the item information; and
determine whether the geographic location of the computing device is within a threshold distance of the geographic location of the delivery point.
